(19) United States
(12) Patent Application Publication
(10) Pub. No.: US 2016/0175775 A1
(43) Pub. Date: Jun. 23, 2016

(54) PROCESS FOR ADSORBING HYDROGEN CHLORIDE FROM A REGENERATION VENT GAS

(71) Applicant: UOP LLC, Des Plaines, IL (US)

(72) Inventors: Clayton C. Sadler, Arlington Heights, IL (US); David A. Wegerer, Lisle, IL (US); Juan Salazar, Chicago, IL (US); Elizabeth Carter, Arlington Heights, IL (US)

(21) Appl. No.: 14/575,527

(22) Filed: Dec. 18, 2014

(51) Int. Cl. B01D 53/86; B01D 53/02

(52) U.S. Cl. CPC B01D 53/8659; B01D 53/02; B01D 2258/0283; B01D 2257/2045

(57) ABSTRACT

A process for adsorbing hydrogen chloride (HCl) from a regeneration vent gas. The regeneration vent gas from a regeneration zone is cooled, and the cooled regeneration vent gas is passed to an adsorption zone that is spaced apart from the regeneration zone. HCl from the regeneration vent gas is adsorbed onto a spent catalyst in the adsorption zone to enrich the spent catalyst with HCl to provide HCl-rich spent catalyst and deplete HCl from the regeneration vent gas to provide HCl-lean regeneration vent gas. The HCl-lean regeneration vent gas is purged as an effluent gas. The HCl-rich spent catalyst is passed to the regeneration zone.

### FIELD OF THE INVENTION

This invention relates generally to adsorbing hydrogen chloride (HCl) from a regeneration vent gas.

### BACKGROUND OF THE INVENTION

Numerous hydrocarbon conversion processes are widely used to alter the structure or properties of hydrocarbon streams. Such processes include isomerization from straight chain paraffinic or olefinic hydrocarbons to more highly branched hydrocarbons, dehydrogenation for producing olefinic or aromatic compounds, reforming to produce aromatics and motor fuels, alkylation to produce commodity chemicals and motor fuels, transalkylation, and others.

Many such processes use catalysts to promote hydrocarbon conversion reactions. These catalysts tend to deactivate for a variety of reasons, including the deposition of carbonaceous material or coke upon the catalyst, sintering or agglomeration or poisoning of catalytic metals on the catalyst, and/or loss of catalytic metal promoters such as halogens. Consequently, these catalysts are typically reactivated in a process called regeneration.

Reactivation can include, for example, removing coke from the catalyst by burning, redispersing catalytic metals such as platinum on the catalyst, oxidizing such catalytic metals, reducing such catalytic metals, replenishing catalytic promoters such as chloride on the catalyst, and drying the catalyst. For example, U.S. Pat. No. 6,153,091 discloses a method for regenerating spent catalyst.

In a some regeneration processes, a catalyst is passed from a hydrocarbon reaction zone (reaction zone) to a catalyst regeneration zone which may include a burn zone, a chlorination zone, a catalyst drying zone, and a catalyst cooling zone. The catalyst includes coke, which is burned off from the catalyst in the burn zone. A chloride, which is a catalytic promoter, is replaced on the catalyst in the chlorination zone. The catalyst is dried in the catalyst drying zone, and cooled in the catalyst cooling zone, and then returned to the reaction zone.

In the chlorination zone, a chlorine-containing species (chloro-species) typically is introduced to contact the catalyst and replenish the chloride. The chloro-species may be chemically or physically sorbed onto the catalyst as chloride or may remain dispersed in a stream that contacts the catalyst. However, the introduced chloro-species causes a flue gas stream vented from the regeneration zone, referred to herein as regeneration vent gas, to contain hydrogen chloride (HCl). Emissions of HCl in the regeneration vent gas pose environmental concerns if the regeneration vent gas is purged to atmosphere. Thus, the regeneration vent gas cannot be purged to atmosphere.

Vapor phase adsorbent processes for removing HCl, such as those described in U.S. Pat. No. 5,837,636, significantly reduce regeneration vent gas HCl emissions without the need for caustic scrubbing. An example HCl adsorption process cools the regeneration vent gas. The cooled regeneration vent gas is contacted with spent catalyst in an adsorption zone where HCl is adsorbed onto the catalyst. The vent gas product from the adsorption zone is depleted in HCl and vented to atmosphere or routed to further downstream processing.

This adsorption zone is conventionally integrated into an existing regeneration zone by retrofitting the adsorption zone into a disengaging hopper through which spent catalyst is introduced into the regeneration zone (typically a vessel). However, such retrofitting in certain cases can be difficult to implement to optimize the performance, operability, and/or maintainability of the adsorption process. Further, retrofitting typically requires significant modification or replacement of the disengaging hopper, which is performed during a unit shutdown, increasing costs.

Additionally, with a conventional retrofitted adsorption zone in a regeneration zone, regeneration gas flows upward in catalyst transfer pipes (CTPs) between the burn zone and the adsorption zone in the disengaging hopper. This regeneration gas contains water due to the catalyst regeneration reactions in lower zones. To prevent condensation in the CTPs, the CTPs must be traced and insulated. The CTPs are removed and tracing disconnected periodically to perform maintenance on the regeneration zone. The pipes must also be handled carefully to avoid damaging the tracing and insulation.

Therefore, there remains a need for effective and efficient processes for adsorbing HCl from a regeneration vent gas.

### SUMMARY OF THE INVENTION

The present invention is directed to providing effective and efficient processes for adsorbing HCl from a regeneration vent gas.

Accordingly, in one aspect of the present invention, the present invention provides a process for adsorbing hydrogen chloride (HCl) from a regeneration vent gas. The regeneration vent gas from a regeneration zone is cooled, and the cooled regeneration vent gas is passed to an adsorption zone that is spaced apart from the regeneration zone. HCl from the regeneration vent gas is adsorbed onto a spent catalyst in the adsorption zone to enrich the spent catalyst with HCl to provide HCl-rich spent catalyst and deplete HCl from the regeneration vent gas to provide HCl-lean regeneration vent gas. The HCl-lean regeneration vent gas is purged as an effluent gas. The HCl-rich spent catalyst is passed to the regeneration zone.

In an aspect of some embodiments, the regeneration zone is disposed within a vessel, and adsorption zone is disposed within one or more additional vessels that are separate from the vessel of the regeneration zone.

In an aspect of some embodiments, the regeneration zone comprises a burn zone and a chlorination zone, and the regeneration vent gas is purged from at least one of the burn zone and the chlorination zone.

In an aspect of some embodiments, said passing the enriched catalyst to the regeneration zone comprises passing the chloride-rich catalyst to a disengaging hopper of the regeneration zone.

In an aspect of some embodiments, a pressure at the burn zone is greater than a pressure within the adsorption zone.

In an aspect of some embodiments, the process further comprises conditioning the HCl-rich spent catalyst before passing the HCl-rich spent catalyst to the regeneration zone.

In an aspect of some embodiments, the conditioning comprises at least one of drying the HCl-rich spent catalyst and cooling the HCl-rich spent catalyst.

In an aspect of some embodiments, the conditioning comprises drying the HCl-rich spent catalyst and cooling the HCl-rich spent catalyst after said drying.

In an aspect of some embodiments, the process further comprises preheating the spent catalyst before said adsorbing, wherein the preheating comprises adsorbing water onto the spent catalyst in a preheating zone upstream of the adsorption zone.

Another aspect of the invention provides a process for adsorbing HCl from a regeneration vent gas. The regeneration vent gas from a regeneration zone is cooled, and the cooled regeneration vent gas is passed to an adsorption zone within an adsorption vessel that is spaced apart from the regeneration zone. HCl from the regeneration vent gas is adsorbed onto a spent catalyst in the adsorption zone to enrich the catalyst with HCl to provide an HCl-rich spent catalyst and deplete HCl from the regeneration vent gas to provide an HCl-lean regeneration vent gas. A conditioning gas is introduced to the adsorption vessel, and the HCl-rich spent catalyst is conditioned. The HCl-lean regeneration vent is purged gas as an effluent gas. The conditioned catalyst is passed to the regeneration zone.

In an aspect of some embodiments, the process further comprises adjusting a condensation temperature of the conditioning gas.

In an aspect of some embodiments, said conditioning comprises at least one of drying the HCl-rich spent catalyst and cooling the HCl-rich spent catalyst.

In an aspect of some embodiments, the conditioning comprises drying the HCl-rich spent catalyst in a drying zone and cooling the dried catalyst in a cooling zone, and the conditioning gas passes through the cooling zone and the drying zone.

In an aspect of some embodiments, the process further comprises heating a vent gas from the cooling zone, and passing the heated vent gas to the drying zone.

In an aspect of some embodiments, the process further comprises contacting a portion of a vent gas from the drying zone with the spent catalyst in a preheating zone to load the spent catalyst with water.

In an aspect of some embodiments, the process further comprises cooling the portion of the vent gas from the drying zone, and passing the cooled vent gas to the preheating zone.

In an aspect of some embodiments, the conditioning gas comprises nitrogen.

In an aspect of some embodiments, the process further comprises passing conditioning gas to the cooling zone, wherein the conditioning gas has a temperature of between 27 C and 93 C (80 F and 200 F).

In an aspect of some embodiments, the process further comprises passing a vent gas including a portion of the conditioning gas from a preheating zone upstream of the adsorption vessel to a disengaging hopper of the regeneration zone, wherein the vent gas includes a portion of the conditioning gas.

Another aspect of the invention provides a process for adsorbing HCl from a regeneration vent gas. The regeneration vent gas from a regeneration zone is cooled, and the cooled regeneration vent gas is passed to an adsorption zone within an adsorption vessel that is separate from the regeneration zone. Spent catalyst from a reaction zone is preheated, where the preheating takes place in a preheating zone. The preheated catalyst is passed to an adsorption zone. HCl from the regeneration vent gas is adsorbed onto the spent catalyst in the adsorption zone, where the adsorbing comprises enriching the catalyst with HCl to provide an HCl-rich spent catalyst and depleting chloride from the regeneration vent gas to provide an HCl-lean regeneration vent gas. A conditioning gas containing nitrogen is introduced to the adsorption vessel, and the HCl-rich spent catalyst is conditioned, wherein the conditioning comprises drying the HCl-rich spent catalyst in a drying zone and cooling the HCl-rich spent catalyst in a cooling zone. A vent gas from the drying zone is contacted with the spent catalyst in the preheating zone, the vent gas including a portion of said conditioning gas. A vent gas from the preheating zone is passed from the preheating zone to the regeneration zone. The HCl-lean regeneration vent gas is passed to atmosphere, and the conditioned catalyst is passed to the regeneration zone.

In yet another aspect of the present invention, a process includes at least two, at least three, or all of the above described aspects of the present invention.

Additional objects, embodiments, and details of the invention are set forth in the following detailed description of the invention.

### BRIEF DESCRIPTION OF THE DRAWING

The drawings are simplified process flow diagrams in which:

The FIGURE shows a process for adsorbing hydrogen chloride from a regeneration vent gas.

### DETAILED DESCRIPTION OF THE INVENTION

Referring to the drawings, the FIGURE shows an example process for adsorbing hydrogen chloride (HCl) from a regeneration vent gas. A regeneration vent gas line 10 outputs regeneration vent gas from a burn zone 12 of a regeneration zone 14. The regeneration zone 14 may be, for instance, disposed in a vessel or regeneration tower. The regeneration zone 14 is used to regenerate spent catalyst from a hydrocarbon reaction zone 16. Example hydrocarbon reaction processes include reforming, isomerization, dehydrogenation, and transalkylation. The example hydrocarbon reaction zone 16 is configured for a catalytic reforming reaction, and includes a reduction zone 20 and zones for first 22, second 24, third 26, and fourth 28 reactions, as will be appreciated by those of ordinary skill in the art. In one or more of the reaction zones 22, 24, 26, 28, catalyst deactivates and becomes spent. Spent catalyst is output via a spent catalyst output line 30 through an (optional) lock hopper 32.

For example, a catalytic reforming reaction is normally effected in the presence of catalyst particles comprised of one or more Group VIII noble metals (e.g., platinum, iridium, rhodium, palladium) and a halogen combined with a porous carrier, such as a refractory inorganic oxide. The halogen is normally chloride. Alumina is a commonly used carrier. The preferred alumina materials are known as the gamma, eta and theta alumina with gamma and eta alumina giving the best results.

A significant property related to the performance of the catalyst is the surface area of the carrier. Catalyst particles are usually spheroidal, having a diameter of from about 1/16th to about ⅛th inch (1.5-3.1 mm), though they may be as large as ¼th inch (6.35 mm).

During the course of a reforming reaction or other hydrocarbon process reactions, catalyst particles become deactivated as a result of mechanisms such as the deposition of coke on the particles; that is, after a period of time in use, the ability of catalyst particles to promote reforming reactions decreases to the point that the catalyst is no longer useful. The spent catalyst must be regenerated before it can be reused in a reforming process.

Accordingly, a spent catalyst having coke is passed from the hydrocarbon reaction zone 16 to the regeneration zone 14. The regeneration zone 14 includes a disengaging hopper 40, which delivers catalyst to the burn zone 12 through one or more conduits such as catalyst transfer pipes (CTPs) 42, preferably by gravity. The burn zone 12 comprises a portion of the regeneration zone 14 in which coke combustion takes place. Coke which has accumulated on surfaces of the catalyst because of the hydrocarbon reactions can be removed by combustion. Coke is comprised primarily of carbon but is also comprised of a relatively small quantity of hydrogen, generally from 0.5 to 10 wt-% of the coke. The mechanism of coke removal includes oxidation to carbon monoxide, carbon dioxide, and water. The coke content of spent catalyst may be as much as 20% by weight of the catalyst weight, but 5-7% is a more typical amount. Coke is usually oxidized at temperatures approximately in the range of 400° C. to 700° C. A circulating burn zone gas line 44 is provided for circulating gas from the burn zone 12. This circulated burn zone gas can be temperature controlled and supplemented with oxygen, if needed.

As a result of the high temperature, catalyst chloride is quite readily removed from the catalyst during coke combustion. A chlorination zone 46, which may be the same zone as the burn zone 12 or a separate, lower, zone, receives a chloro-species input via a chloro-species input line (not shown) to replenish chloride. For the example process shown in the FIGURE, the chlorination zone 46 is separate from the burn zone 12. A circulating chlorination zone gas line 48 circulates chlorination zone gas, and the circulating burn zone gas line 44 circulates burn zone gas. The regeneration vent gas 10 from the regeneration zone 14, e.g., the gas from the burn zone 12, and in a particular example the gas that is circulated through the circulating burn zone gas line 44, contains HCl.

In the chlorination zone 46, the catalyst metal can be dispersed. The dispersion typically involves chlorine or another chloro-species that can be converted in the regeneration zone to chlorine. The chlorine or chloro-species is generally introduced in a small stream of carrier gas that is added to the chlorination zone. Although the actual mechanism by which chlorine disperses catalyst metal is the subject of a variety of theories, it is generally recognized that the metal may be dispersed without increasing the catalyst chloride content. In other words, although the presence of chlorine is a requirement for metal dispersion to occur, once the metal has been dispersed it is not necessary that the catalyst chloride content be maintained above that of the catalyst prior to dispersion. Thus, the agglomerated metals on catalyst can be dispersed without a net increase in the overall chloride content of the catalyst. Notwithstanding same, in the chlorination zone the gas may also replace chloride on the catalyst.

The regenerated catalyst from the chlorination zone 46 is dried in a drying zone 50 to remove water. The dried catalyst, which may be cooled, passes (e.g., by gravity) via a dried catalyst output line 51 through a flow control hopper 52, a surge hopper 54, and a lock hopper 56, before being passed to the reduction zone 20 in the hydrocarbon reaction zone 16 via conduit 58 and then reused in hydrocarbon reaction processes.

In an example process, to adsorb HCl from the regeneration vent gas line 10, the regeneration vent gas is cooled, e.g., in a cooler 59, from a temperature of 482 C-593 C (900 F-1100 F) to a temperature of around 38 C-190 C (100 F-375 F). The cooled regeneration vent gas is passed from the regeneration zone 14, e.g., from the burn zone 12 or the chlorination zone 46, and in a particular example from the circulating burn zone gas line 44, to an adsorption zone 60 that is spaced apart from the regeneration zone 14. By “spaced apart,” it is intended that the adsorption zone 60 be separated from the regeneration zone by a distance, except for connecting lines such as the regeneration vent gas line 10 or other lines. In an example process, the regeneration zone 14 is disposed within a vessel, and the adsorption zone is disposed within an adsorption vessel 62 that is separate from the vessel of the regeneration zone. The adsorption vessel 62 can include, for example, a separate stack of modules that are shop fabricated. This allows improved quality control, and reduces or eliminates modification to existing equipment such as the regeneration zone 14.

In the adsorption zone 60, HCl from the regeneration vent gas is adsorbed onto spent catalyst in a vapor phase adsorption to provide HCl-rich catalyst, and deplete HCl from the regeneration vent gas to provide HCl-lean regeneration vent gas. The spent catalyst can be supplied from the hydrocarbon reaction zone 16 via spent catalyst input line 63. The HCl-lean regeneration vent gas is purged as an effluent gas, e.g., by venting the gas to atmosphere via purge line 65.

In an example process, the adsorption vessel 62 includes multiple zones, including a preheat zone 64 where the spent catalyst is preheated by heat transfer from a conditioning gas to spent catalyst and by adsorbing water (as will be explained in more detail below), the adsorption zone 60 where HCl from the regeneration vent gas is adsorbed onto the spent catalyst, and one or more conditioning zones for conditioning the HCl-rich spent catalyst. In the example process shown in the FIGURE, the conditioning zones include a drying zone 68 where the HCl-rich spent catalyst is dried, and a cooling zone 70 where the dried catalyst is cooled. Other conditioning zones are possible. The conditioned HCl-rich catalyst exits the adsorption vessel 62 via an output line 72 and a lock hopper 74, and is passed to the disengaging hopper 40 of the regeneration zone 14 via a catalyst input line 76 for catalyst regeneration.

In the process shown in the FIGURE, the preheating zone 64, the adsorption zone 60, the drying zone 68, and the cooling zone 70 can be embodied in cylindrical volumes of catalyst. Cylindrical baffles can be provided to provide spaces for gas to enter and distribute around the zones 60, 64, 68, 70. The height of the cylindrical volumes can be selected, for instance, to provide desired mass transfer, and to distribute the gas throughout the cylindrical volume.

In an alternative process, in at least one of the zones 60, 64, 68, 70, gas flows in the radial direction and spent catalyst flows in the axial direction. This arrangement allows much lower bed depths thereby reducing bed pressure drop and the catalyst volume requirements in the adsorption vessel 62. However, the cylindrical arrangement, being counter-current, may be preferred over a cross flow arrangement such as a radial flow configuration for overall heat and mass transfer efficiency.

A conditioning gas is introduced to the adsorption vessel 62 from a conditioning gas input line 80 for conditioning the catalyst. The conditioning gas includes nitrogen. The conditioning gas input line 80 can be supplied with conditioning gas from a circulating elutriation and lift gas system. An example elutriation and lift gas system includes a gas output line 82 from the regeneration zone 14, for example from the disengaging hopper 40, where solid catalyst from the catalyst input line 76 is separated from lift gas in the regeneration zone. A dust collector 84 collects dust (e.g., catalyst particles) from the elutriation and lift gas output line 82. An elutriation and lift gas blower 86 in the example elutriation and lift gas system supplies elutriation gas to the disengaging hopper 40 via circulating elutriation gas line 88, to the reaction zone 16 via reaction zone lift gas input line 90, to the adsorption zone outlet and regeneration zone catalyst input line 76 via lift gas input line 92, and to the adsorption vessel 62, e.g., to the cooling zone 70, as conditioning gas via the conditioning gas input line 80.

The conditioning zones, such as the drying zone 68 and the cooling zone 70, condition the HCl-rich catalyst exiting the adsorption zone 60 to control the condensation temperature of the conditioning gas. This condensation temperature in the circulating elutriation and lift gas system is a function of pressure and water content of the catalyst entering and exiting the adsorption vessel 62. For an adsorption zone operating near atmospheric pressure, if the catalyst exiting the adsorption zone 60 enters the circulating elutriation and lift gas system directly, the water condensation temperature may exceed a temperature that would significantly increase the risk of condensation in an overall system (e.g., the hydrocarbon reaction zone 16, the regeneration zone 14, and the adsorption zone 12), particularly for systems in colder climates.

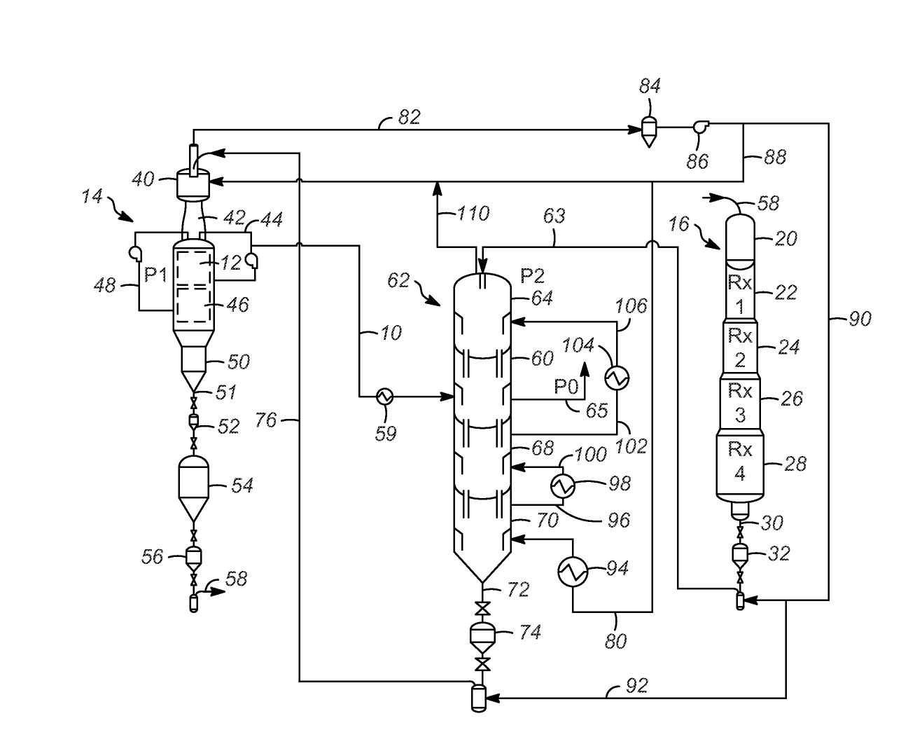

Thus, prior to entering the elutriation and lift gas system, the spent catalyst is conditioned in the conditioning zones, such as (but not limited to) the drying zone 68 and the cooling zone 70. In the example process shown in FIG. 1, the conditioning gas from conditioning gas input line 80 is cooled, e.g., in cooler 94, to a temperature between about 27 C to 93 C (80 F to 200 F), and the cooled conditioning gas is passed to the cooling zone 70. The cooled conditioning gas cools the HCl-rich spent catalyst in the cooling zone 70, and partially heats the conditioning gas. The (partially heated) conditioning gas is vented via a cooling zone vent gas output line 96, and is heated, e.g., using a heater 98. The heated conditioning gas is input to the drying zone 68 via heated conditioning gas input line 100.

In the drying zone 68, water (H2O) content in the HCl-rich spent catalyst is reduced to provide a dried catalyst. Further, the (nitrogen-containing) vent gas from the drying zone 68 is enriched in water. To reduce the water content from this vent gas, and thus to keep the condensation temperature in the lift gas system below about −17 C to −51 C (0 F to −60 F), the water-enriched vent gas is vented from the drying zone via drying zone vent gas line 102 and is cooled in a preheat gas cooler 104 to a temperature between about 66 C to 177 C (150 F to 350 F).

The cooled drying zone vent gas is passed via preheat zone gas input line 106 to the preheat zone 64, which is upstream of the adsorption zone 60. In the preheat zone 64, the cooled drying zone vent gas contacts the spent catalyst that is loaded via spent catalyst input line 63. This contacting partially loads the spent catalyst with water before the spent catalyst enters the adsorption zone 60. Vent gas from the preheat zone 64 is passed to the elutriation and lift gas system via preheat zone vent gas line 110, which can then be introduced to the disengaging hopper via elutriation gas line 88.

In the process shown in the FIGURE, the adsorption zone 60 is in communication with the regeneration zone 14, and the preheating zone 64, the drying zone 68, and the cooling zone 70 are in communication with the disengaging hopper 40 and the lift gas system.

In the process shown in the FIGURE, the burn zone 12 is at a higher pressure than the adsorption zone 60, and the disengaging hopper 40 is at a higher pressure than the burn zone 12. For example, for a pressure P1 within the burn zone 12, a pressure P2 within the preheating zone, and a pressure P0 at atmosphere at line 65 (e.g., for an atmospheric application), P2>P1>P0.

The arrangement and pressure differences allow an example process to “seal” wet gas in the adsorption zone 60 and regeneration burn zone 12 with the use of a catalyst conduit such as catalyst transfer pipes (CTPs). CTPs enable movement of the catalyst between the zones contained in regeneration zone 14 and adsorption vessel 62 while restricting gas flow. Gas flow and catalyst flow can be cocurrent or countercurrent within the CTPs.

It should be appreciated and understood by those of ordinary skill in the art that various other components such as valves, pumps, filters, coolers, etc. were not shown in the drawings as it is believed that the specifics of same are well within the knowledge of those of ordinary skill in the art and a description of same is not necessary for practicing or understating the embodiments of the present invention.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A process for adsorbing hydrogen chloride (HCl) from a regeneration vent gas, the process comprising:
cooling the regeneration vent gas from a regeneration zone;
passing the cooled regeneration vent gas to an adsorption zone that is spaced apart from the regeneration zone;
adsorbing HCl from the regeneration vent gas onto a spent catalyst in the adsorption zone to enrich the spent catalyst with HCl to provide HCl-rich spent catalyst and deplete HCl from the regeneration vent gas to provide HCl-lean regeneration vent gas;
purging the HCl-lean regeneration vent gas as an effluent gas; and
passing the HCl-rich spent catalyst to the regeneration zone.

2. The process of claim 1, wherein the regeneration zone is disposed within a vessel, and wherein the adsorption zone is disposed within one or more additional vessels that are separate from the vessel of the regeneration zone.

3. The process of claim 1, wherein the regeneration zone comprises a burn zone and a chlorination zone, and wherein the regeneration vent gas is purged from at least one of the burn zone and the chlorination zone.

4. The process of claim 3, wherein said passing the enriched catalyst to the regeneration zone comprises passing the chloride-rich catalyst to a disengaging hopper of the regeneration zone.

5. The process of claim 4, wherein a pressure at the burn zone is greater than a pressure within the adsorption zone.

6. The process of claim 1, further comprising:
conditioning the HCl-rich catalyst before passing the HCl-rich catalyst to the regeneration zone.

7. The process of claim 6, wherein said conditioning comprises at least one of drying the HCl-rich catalyst and cooling the HCl-rich catalyst.

8. The process of claim 7, wherein said conditioning comprises drying the HCl-rich catalyst and cooling the HCl-rich catalyst after said drying.

9. The process of claim 1, further comprising:
preheating the spent catalyst before said adsorbing, wherein said preheating comprises adsorbing water onto the spent catalyst in a preheating zone upstream of the adsorption zone.

10. A process for adsorbing HCl from a regeneration vent gas, the process comprising:
cooling the regeneration vent gas from a regeneration zone;
passing the cooled regeneration vent gas to an adsorption zone within an adsorption vessel that is spaced apart from the regeneration zone;
adsorbing HCl from the regeneration vent gas onto a spent catalyst in the adsorption zone to enrich the catalyst with HCl to provide an HCl-rich spent catalyst and deplete HCl from the regeneration vent gas to provide an HCl-lean regeneration vent gas;
introducing a conditioning gas to the adsorption vessel;
conditioning the HCl-rich spent catalyst;
purging the HCl-lean regeneration vent gas as an effluent gas; and
passing the conditioned catalyst to the regeneration zone.

11. The process of claim 10, further comprising:
adjusting a condensation temperature of the conditioning gas.

12. The process of claim 10, wherein said conditioning comprises at least one of drying the HCl-rich spent catalyst and cooling the HCl-rich spent catalyst.

13. The process of claim 10, wherein said conditioning comprising drying the HCl-rich spent catalyst in a drying zone and cooling the dried catalyst in a cooling zone; and
wherein the conditioning gas passes through the cooling zone and the drying zone.

14. The process of claim 13, further comprising:
heating a vent gas from the cooling zone; and passing the heated vent gas to the drying zone.

15. The process of claim 13, further comprising:
contacting a portion of a vent gas from the drying zone with the spent catalyst in a preheating zone to load the spent catalyst with water.

16. The process of claim 15, further comprising:
cooling the portion of the vent gas from the drying zone; and passing the cooled vent gas to the preheating zone.

17. The process of claim 16, wherein the conditioning gas comprises nitrogen.

18. The process of claim 16, further comprising:
passing conditioning gas to the cooling zone, wherein the conditioning gas has a temperature of between 27 C and 93 C (80 F and 200 F).

19. The process of claim 10, further comprising:
passing a vent gas including a portion of the conditioning gas from a preheating zone upstream of the adsorption zone to a disengaging hopper of the regeneration zone, wherein the vent gas includes a portion of the conditioning gas.

20. A process for adsorbing HCl from a regeneration vent gas, the process comprising:
cooling the regeneration vent gas from a regeneration zone;
passing the cooled regeneration vent gas to an adsorption zone within an adsorption vessel that is separate from the regeneration zone;
preheating spent catalyst from a reaction zone, said preheating taking place in a preheating zone;
passing the preheated catalyst to an adsorption zone;
adsorbing HCl from the regeneration vent gas onto the spent catalyst in the adsorption zone, said adsorbing enriching the catalyst with HCl to provide an HCl-rich spent catalyst and depleting HCl from the regeneration vent gas to provide an HCl-lean regeneration vent gas;
introducing a conditioning gas containing nitrogen to the adsorption vessel;
conditioning the HCl-rich spent catalyst, wherein said conditioning comprises drying the HCl-rich spent catalyst in a drying zone and cooling the HCl-rich spent catalyst in a cooling zone;
contacting a vent gas from the drying zone with the spent catalyst in the preheating zone, the vent gas including a portion of said conditioning gas;
passing a vent gas from the preheating zone to the regeneration zone;
purging the HCl-lean regeneration vent gas to atmosphere; and
passing the conditioned catalyst to the regeneration zone.
